(19) United States
(12) Patent Application Publication
(10) Pub. No.: US 2008/0078459 A1
(43) Pub. Date: Apr. 3, 2008

(54) Rotary hydraulic damper for check valve

(75) Inventors: Jeremiah J. Warriner, Laveen, AZ (US); Joseph J. Jira, Laveen, AZ (US); G. Stephen McGonigle, Gilbert, AZ (US); Stuart K. Denike, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/540,776

(22) Filed: Sep. 29, 2006

(51) Int. Cl. F16K 15/03; F16K 21/10

(52) U.S. Cl. 137/512.1; 137/514

(57) ABSTRACT

A damping system for a valve with a flapper comprises a main body having at least an inner wall defining a chamber having fluid therein, a paddle disposed within the chamber, and a fluid channel. The paddle is coupled to the flapper and moved thereby between a first and second position when the flapper is in a closed and an open position, respectively, and is configured to force fluid from at least a section of the chamber when approaching the first or second position. The fluid channel is coupled to the chamber section, and is configured to allow fluid egress out of the chamber section at a first egress rate when the paddle moves from the first position to a predetermined intermediate position between the first and second positions, and at a second, lower egress rate when the paddle moves from the predetermined intermediate position to the second position.

### TECHNICAL FIELD

The present invention relates generally to a check valve and, more particularly, to a check valve with a hydraulic damping mechanism.

### BACKGROUND

Insert style check valves are used to control air flow in a pneumatic system, and may be installed for the purpose of reducing system weight and costs. For example, the check valves may be used to replace larger, body style check valves that are in ducts of the pneumatic system. Generally, check valves operate by moving between a closed position, where the valve seals the duct and prevents air from flowing in a reverse direction, and an open position, where the valve unseals the duct and allows air flow in a forward direction. Such check valves, while generally safe, reliable, and robust, can experience some wear and/or noise, for example when the valves open and close.

Accordingly, there is a need for a check valve with reduced wear and/or noise when opening and closing. The present invention addresses at least this need.

### BRIEF SUMMARY

The present invention provides a damping system for a check valve.

In one embodiment, and by way of example only, a check valve comprises a valve body, a flapper, and a damping mechanism. The valve body has an upstream side, a downstream side, and a valve flow channel that extends between the upstream and downstream sides. The flapper is rotationally mounted on the valve body, and is movable between a closed position, in which the flapper at least substantially seals the valve flow channel, and an open position, in which the flapper at least substantially unseals the valve flow channel. The damping mechanism is mounted on the valve body, and comprises a main body, a paddle, and a fluid channel. The main body has at least an inner wall defining a chamber, the chamber having fluid therein. The paddle is disposed within the chamber. The paddle is coupled to the flapper, and is moved thereby between a first position and a second position when the flapper is in the closed position and the open position, respectively. The paddle is configured to force fluid from at least a section of the chamber when approaching the first position or the second position. The fluid channel is coupled to at least the section of the chamber. The fluid channel is configured to allow egress of the fluid out of the section of the chamber at least at a first egress rate when the paddle moves from the first position to a predetermined intermediate position between the first and second positions, and to allow egress of the fluid out of the section of the chamber at least at a second egress rate when the paddle moves from the predetermined intermediate position to the second position, the second egress rate being less than the first egress rate. Movement of the flapper from the closed position to the open position is at least at a first movement rate when the paddle moves from the first position to the intermediate position, and is at least at a second movement rate when the paddle moves from the predetermined intermediate position to the second position, the second movement rate being less than the first movement rate.

In another embodiment, and by way of example only, a check valve comprises a valve body, a plurality of flappers, and a plurality of damping mechanisms. The valve body has an upstream side, a downstream side, and a plurality of valve flow channels that extend between the upstream and downstream sides. The plurality of flappers are rotationally mounted on the valve body. Each flapper is movable between a closed position, in which such flapper at least substantially seals a valve flow channel, and an open position, in which such flapper at least substantially unseals a valve flow channel. The plurality of damping mechanisms are mounted on the valve body, and each damping mechanism comprises a main body, a paddle, and a fluid channel. The main body has at least an inner wall defining a chamber, the chamber having fluid therein. The paddle is disposed within the chamber. The paddle is coupled to a corresponding flapper, and is moved thereby between a first position and a second position when the corresponding flapper is in the closed position and the open position, respectively. The paddle is configured to force fluid from at least a section of the chamber when approaching the first position or the second position. The fluid channel is coupled to at least the section of the chamber. The fluid channel is configured to allow egress of the fluid out of the section of the chamber at least at a first egress rate when the paddle moves from the first position to a predetermined intermediate position between the first and second positions, and to allow egress of the fluid out of the section of the chamber at least at a second egress rate when the paddle moves from the predetermined intermediate position to the second position, the second egress rate being less than the first egress rate. Movement of the corresponding flapper from the closed position to the open position is at least at a first movement rate when the paddle moves from the first position to the intermediate position, and is at least at a second movement rate when the paddle moves from the predetermined intermediate position to the second position, the second movement rate being less than the first movement rate.

In yet another embodiment, and by way of example only, a damping system, for a valve with a flapper movable between an open position and a closed position, comprises a main body, a paddle, and a fluid channel. The main body has at least an inner wall defining a chamber, the chamber having fluid therein. The paddle is disposed within the chamber. The paddle is coupled to the flapper, and is moved thereby between a first position and a second position when the flapper is in the closed position and the open position, respectively. The paddle is configured to force fluid from at least a section of the chamber when approaching the first position or the second position. The fluid channel is coupled to at least the section of the chamber. The fluid channel is configured to allow egress of the fluid out of the section of the chamber at least at a first egress rate when the paddle moves from the first position to a predetermined intermediate position between the first and second positions, and to allow egress of the fluid out of the section of the chamber at least at a second egress rate when the paddle moves from the predetermined intermediate position to the second position, the second egress rate being less than the first egress rate. Movement of the flapper from the closed position to the open position is at least at a first movement rate when the paddle moves from the first position to the intermediate position, and is at least at a second movement rate when the paddle moves from the predetermined intermediate position to the second position, the second movement rate being less than the first movement rate.

Other independent features and advantages of the preferred systems will become apparent from the following detailed description, taken in conjunction with the accompanying drawings which illustrate, by way of example, the principles of the invention.

### BRIEF DESCRIPTION OF THE DRAWINGS

FIG. 1 is a simplified schematic diagram illustrating an air distribution system;

FIG. 2 provides a perspective plan view, from a downstream side and in a partially open position, of an exemplary embodiment of a check valve that may be used in the system of FIG. 1;

FIG. 3 provides an end view from a downstream side of the valve of FIG. 2;

FIG. 4 provides a close-up view of a portion of the exemplary valve of FIGS. 2-3, depicting an exemplary embodiment of a damping mechanism that can be used in the valve, and shown in a position corresponding with the valve in a closed position;

FIG. 5 provides another close-up view of a portion of the exemplary valve of FIGS. 2-3, depicting an exemplary embodiment of a damping mechanism that can be used in the valve, and shown in a position corresponding with the valve in a partially open position;

FIG. 6 provides a detailed view of the damping mechanism of FIGS. 4-5, shown in a position corresponding with the valve in a partially open position;

FIG. 7 provides a perspective plan view of an exemplary embodiment of a hinge pin that can be used in the valve of FIGS. 2-3;

FIG. 8 provides a perspective plan view of an exemplary embodiment of a paddle of the damping mechanism of FIGS. 4-5 with a keyway hole that can be coupled to the hinge pin of FIG. 7; and

FIG. 9 provides a perspective plan view of an exemplary embodiment of the hinge pin of FIG. 7 and the damping mechanism of FIGS. 4-5 coupled to a flapper element.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background or the following detailed description. In this regard, although the invention is described herein as being implemented in an air distribution system, it will be appreciated that it could also be implemented in any one of numerous other types of systems that direct the flow of various types of fluid, both within or apart from an aircraft, and/or any one of numerous other types of vehicles or other types of apparatus or systems.

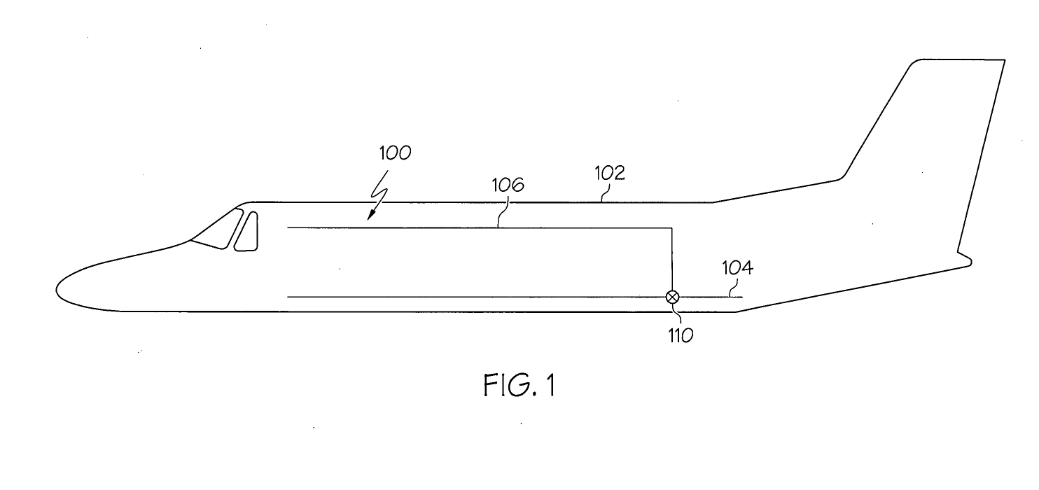

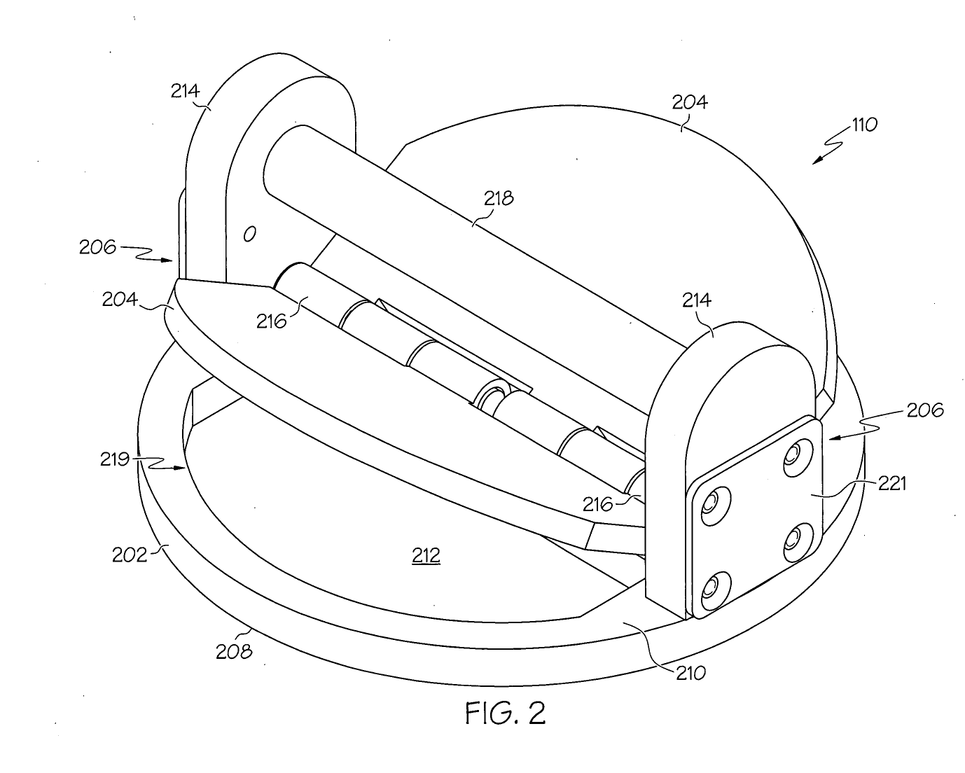

FIG. 1 is a simplified schematic diagram illustrating an air distribution system 100 disposed within an aircraft 102. The air distribution system 100 includes an inlet duct 104, one or more outlet ducts 106 (only one of which is shown here), and a valve 110 positioned in the duct 106. The inlet duct 104 receives air from an air source, such as, for example, engine bleed air, and the outlet duct 106 exhausts air into desired sections of the aircraft 102. In one exemplary embodiment, the outlet duct 106 exhausts air into or out of an aircraft cabin (not shown). The valve 110 is configured to control the air flow through the outlet duct 106 and to prevent the air from flowing in a reverse direction. An exemplary embodiment of the valve 110 is depicted in FIGS. 2-11, and will now be described in more detail.

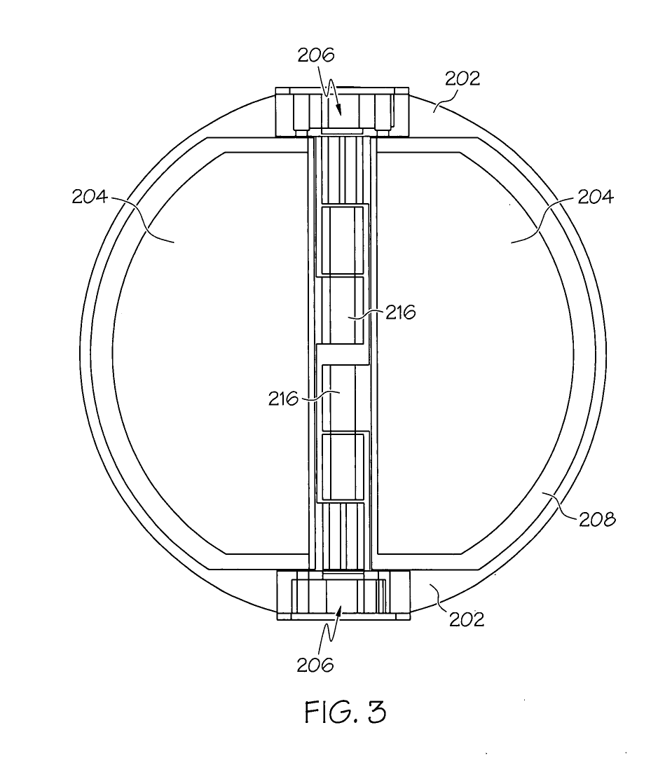

Turning first to FIGS. 2-3, perspective plan views of the valve 110 are provided from the downstream side, in a partially open position (FIG. 2), and from the downstream side in the closed position (FIG. 3). The valve 110 includes a valve body 202, a pair of flappers 204, and one or more damping mechanisms 206.

The valve body 202 is annular in shape and includes an upstream side 208, a downstream side 210, and a pair of flow channels 212 that extend between the upstream and downstream sides 208, 210. The valve body 202 also includes a pair of support flanges 214 that extend axially from the valve body downstream side 210. A plurality of hinge pins 216 are disposed in, and a stop tube 218 is coupled to, and extends between, the support flanges 214. The purpose of these components is described further below.

The flappers 204 are rotationally mounted on the valve body 202, and are movable between a closed position and a full-open position. In the closed position, the flappers 204 engage a seat region 219 (see FIG. 2) on the valve body 202 to seal, or at least substantially seal, a corresponding flow channel 212. In the full-open position, or any one of numerous open positions between the closed and full-open positions (e.g., see FIG. 2), the flappers 204 unseal the corresponding flow channel 212. Thus, when the flappers 204 are in the closed position, fluid flow through the flow channels 212 is prevented, or at least substantially inhibited, and when the flappers 204 are in an open position, fluid flow through the flow channels 212 is allowed. Rotational movement of the flappers 204 is limited by the stop tube 218.

The valve 110 is preferably configured such that both flappers 204 are simultaneously in either the closed or an open position. However, as will also be described further below, this is merely exemplary of a particular embodiment, and the valve 110 could be configured such that each flapper 204 may be individually moved to an open position. Moreover, although the valve 110 is preferably implemented with a pair of flow channels 212 and an associated pair of flappers 204, it will be appreciated that the valve 110 could, in an alternative embodiment, be implemented with more or less than this number of flow channels 212 and flappers 204.

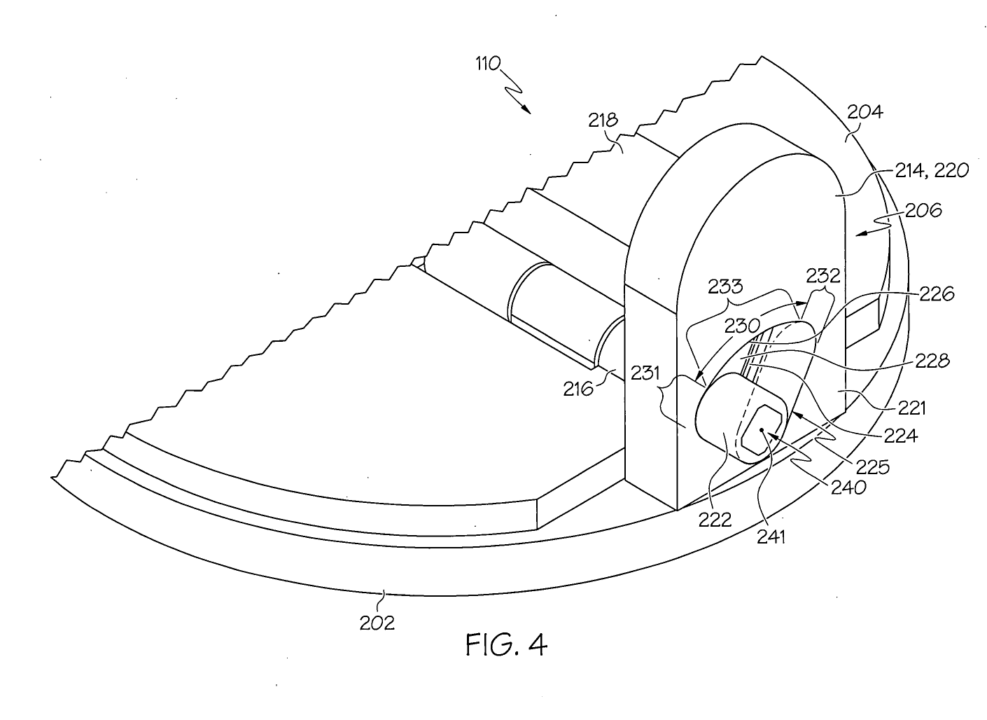

The one or more damping mechanisms 206 are each configured to provide damping when the flappers 204 open and close, thereby reducing wear and noise during operation of the valve 110. In the depicted split flapper valve 110, there are preferably two damping mechanisms 206 on opposite sides of the flapper valve 110, each damping mechanism 206 coupled to a separate corresponding flapper 204. However, it will be appreciated that the number of damping mechanisms 206 may vary depending on the type of valve 110. An exemplary embodiment of a damping mechanism 206 is shown in detail with various views in FIGS. 4-9, and with reference thereto will now be described.

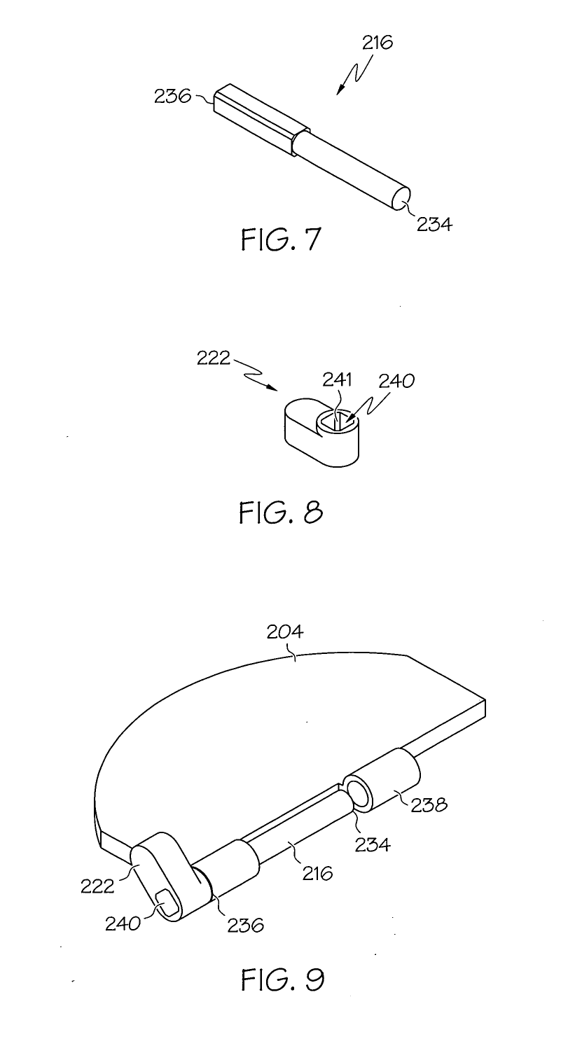

Specifically, FIGS. 4-6 depict the damping mechanism 206 with at least a partially transparent cover 221 in order to better depict the various features of the damping mechanism 206. FIGS. 7-9 depict a preferred embodiment for coupling the damping mechanism 206 to a corresponding flapper 204.

As shown in FIGS. 4-6, the damping mechanism 206 is mounted on the valve body 202, and includes a main body 220, a paddle 222, and a one or more fluid channels 224. The damping mechanism 206 preferably also includes one or more seals 225.

The main body 220, which in the depicted embodiment is integrally formed as part of one of the support flanges 214 (see FIG. 4), has at least an inner wall 226 that defines a chamber 228 having fluid therein. The main body 220 is coupled to the valve body 202, and is preferably also coupled to the stop tube 218. In the depicted embodiment having two damping mechanisms 206, preferably each damping mechanism 206 is mounted on an opposite end of the valve body 202. The fluid contained in the chamber 228 can be oil, or any one of numerous suitable types of incompressible, or at least substantially incompressible, fluid. In certain embodiments, the type of fluid may be selected based at least in part on the viscosity of the fluid, and the resulting effect on the speed of the damping for the valve 110.

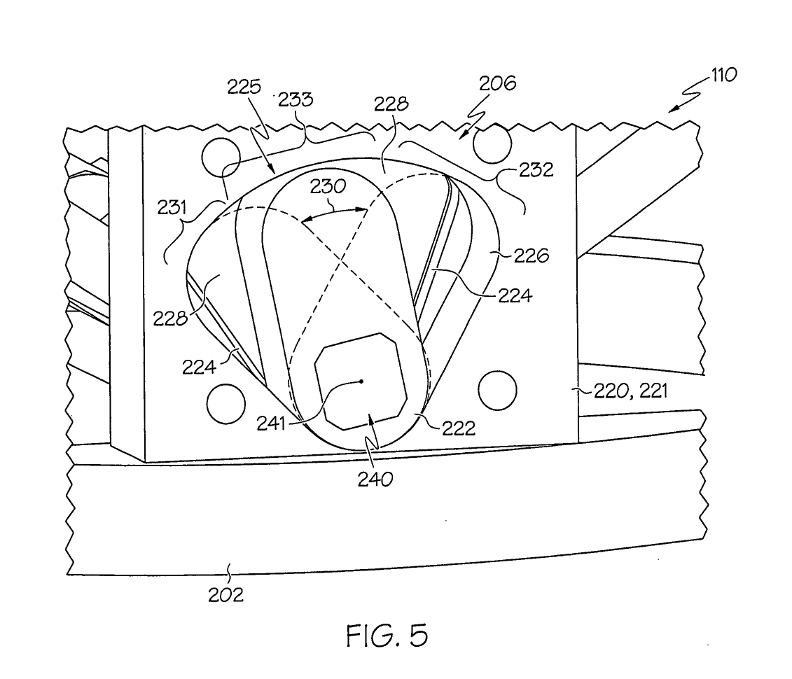

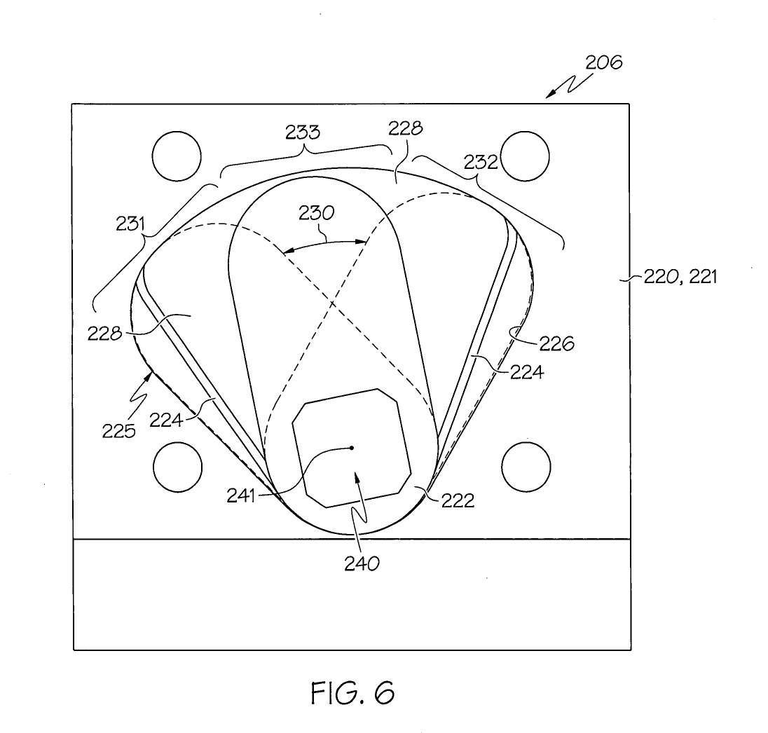

The paddle 222 is disposed within the chamber 228. The paddle 228 is coupled to a corresponding flapper 204, and is moved thereby between a first position (depicted in FIG. 4, and in phantom in FIGS. 5 and 6) and a second position (shown in phantom in FIGS. 4-6), when the corresponding flapper 204 is in the closed position and the full-open position, respectively. The paddle 222 is configured to force the fluid out of a section of the chamber 228 when moving to the first position or the second position. Preferably the paddle 222 moves between the first and second positions along a path 230, during which the paddle 222 takes one or more intermediate positions (depicted in FIGS. 5 and 6) between the first and second positions.

As will be described in greater detail further below, preferably the paddle 222 includes a keyway hole 240 with a center 241, and the inner wall 226 preferably defines, along the path 230, an arc including at least a first region 231, a second region 232, and an intermediate region 233 between the first and second regions 231, 232. Preferably the distance between the keyway hole center 241 and the intermediate section 233 is greater than the distance between the keyway hole center 241 and the first region 231 and the second region 232. As a result, the fluid in the chamber 228 is able to flow around the paddle 222 when the paddle 222 is not at least partially adjacent to the first region 231 or the second region 232 of the inner wall 226, for example when the paddle 222 is in an intermediate position. However, fluid flow is at least substantially restricted when the paddle 222 is at least partially adjacent to the first region 231 or the second region 232 of the inner wall 226, for example when the paddle 222 approaches the first or second position. As the paddle 222 approaches the first or second position, the paddle 222 compresses the fluid in a section of the chamber 228 proximate the paddle 222 and forces the fluid out of that section of the chamber 228 through the one or more fluid channels 224 discussed below.

The one or more fluid channels 224 are coupled to at least the section of the chamber 228 proximate the paddle 222 when the paddle 222 is in the first or the second position. Preferably the one or more fluid channels 224 fluidly couple two or more sections of the chamber 228, including one section proximate the paddle 222 when the paddle 222 is in the first position, and another section proximate the paddle 222 when the paddle 222 is in the second position.

In various embodiments, the one or more fluid channels 224 may be implemented by forming a groove within the inner wall 226, boring one or more channels within the main body 220 connecting various points or sections within the chamber 228, and/or any one of a number of other different types of devices or configurations allowing for egress of fluid from one section of the chamber 228 and ingress of the fluid to another section of the chamber 228. However, it will be appreciated that in other embodiments the fluid may be able to egress from the section and subsequently ingress directly back to the same section of the chamber 228, for example if the one or more fluid channels 224 are relatively deep and/or lead to a temporary holding place outside of the chamber 228.

In addition, in certain embodiments, the shape and/or size of the one or more fluid channels 224 can be tailored to the specific damping needs of the particular valve 110. For example, the one or more fluid channels 224 may include a groove that is smaller near its ends and larger near its middle section, if greater damping is desired as the paddle 222 approaches either the first or second position. It will similarly be appreciated that the one or more fluid channels 224 can take any one of numerous other configurations depending on the desired damping speeds and/or other desired features for a particular valve 110.

Regardless of their particular configuration, the one or more fluid channels 224 are configured, along with the above-referenced arc along the inner wall 226 of the chamber 228, to allow egress of the fluid out of the section of the chamber 228 at least at a first aggregate egress rate when the paddle 222 moves from the first or second position to a predetermined intermediate position between the first and second positions, and to allow egress of the fluid out of the section of the chamber 228 at least at a second aggregate egress rate when the paddle 222 moves from the predetermined intermediate position to the first or the second position, the second aggregate egress rate being less than the first aggregate egress rate.

For example, in the preferred embodiment discussed above, fluid egresses out of the section of the chamber 228 relatively quickly as the paddle 222 approaches the intermediate positions, during which fluid is free to flow around the paddle 222. During this time, at least some of the fluid may also be able to simultaneously flow through the one or more fluid channels 224, thereby further increasing the speed at which fluid egresses out of the section of the chamber 228. Conversely, when the paddle 222 approaches the first or second position, fluid egresses out of the section of the chamber 228 relatively slowly. During this time, the paddle 222 is adjacent to the first or second sections 231, 232 of the inner wall 226, thereby restricting fluid flow around the paddle 222 and, accordingly, at least substantially limiting fluid egress out of the section of the chamber 228 to the one or more fluid channels 224.

Thus, the paddle 222 moves relatively quickly while in an intermediate position and relatively slowly as it approaches the first or second position. Accordingly, in turn, the flapper 204 moves relatively quickly as the flapper 204 begins to open or close, and relatively slowly as the flapper 204 is approaching the full-open or closed position. This provides the desired damping effect, thereby reducing wear and noise for the valve 110.

The seals 225 are preferably disposed in one or more places in or around the damping mechanism 206, for example, surrounding the chamber 228, and help to restrict the fluid from escaping from the chamber 228. Preferably, the seals 225 are placed where fluid intended for damping may otherwise escape unintentionally. It will be appreciated that the seals 225 may also be disposed in any one or more of numerous other locations in or around the damping mechanism 206, and that in certain embodiments seals 225 may not be needed.

As shown in greater detail in FIGS. 7-9, the paddle 222 in the depicted embodiment is coupled to the corresponding flapper 204 via the above-referenced hinge pin 216. The hinge pin 216 preferably includes at least a round end 234 and a keyway end 236. The round end 234 is-configured to be inserted and held in place in a hinge pin guide 238 that is coupled to the flapper 204, preferably with a tight fit around the round end 234. The keyway end 236 is configured to be inserted into the above-mentioned keyway hole 240 in the paddle 222, to thereby drive movement of the paddle 222 when the corresponding flapper 204 moves between the open and closed positions. However, it will be appreciated that the paddle 222 may be coupled to the corresponding flapper 204 in any one of numerous different manners. In the depicted embodiment of the valve 110 having two flappers 204 and two damping mechanisms 206, there are two hinge pins 216, each coupling a different flapper 204 with a corresponding damping mechanism 206. It will also be appreciated that, in various other embodiments, any one of numerous different types of shafts are other coupling devices can be used instead of, or in addition to, the hinge pins 216.

Having generally described the damping mechanism 206, a more detailed description of the operation of the particular embodiment of the damping mechanism 206 will now be described, assuming that the flappers 204 are initially in the closed position. As the flappers 204 begin to open, the corresponding paddles 222 move within their respective chambers 228 from the first position to an intermediate position along the path 230. During this time, the paddles 222 compress the fluid in one section of the chambers 228. Because the fluid is free to flow around the paddles 222, as well as through the fluid channels 224, there is a relatively lower amount of resistance against movement of the paddles 222. Accordingly, the paddles 222, and therefore also the corresponding flappers 204, move relatively quickly during this time.

Then, as the flappers 204 approach the full-open position and the paddles 222 thereby approach the second position, and are at least partially adjacent to the second section 232 of the inner wall 226, fluid flow around the paddles 222 is at least substantially blocked. The fluid is therefore further compressed by the paddles 222 in the corresponding sections of the chambers 228 and escapes at a lower rate, through the fluid channels 224. Thus, there is a relatively higher amount of resistance provided by the fluid against movement of the paddles 222. Accordingly, the paddles 222, and therefore also the corresponding flappers 204, move relatively slowly during this time.

Conversely, as the flappers 204 begin to close, the corresponding paddles 222 move through the respective chambers 228 from the second position to an intermediate position along the path 230. During this time, the paddles 222 compress the fluid in one section of the chambers 228. Because the fluid is free to flow around the paddles 222, as well as through the fluid channels 224, there is a relatively lower amount of resistance against movement of the paddles 222. Accordingly, the paddles 222, and therefore also the corresponding flappers 204, move relatively quickly during this time.

Then, as the flappers 204 approach the closed position and the corresponding paddles 222 thereby approach the first position and are at least partially adjacent to the first section 231 of the inner wall 226, fluid flow around the paddles 222 is at least substantially blocked. The fluid is therefore further compressed by the paddles 222 in the corresponding sections of the chambers 228 and escapes at a lower rate, through the fluid channels 224. Thus, there is a relatively higher amount of resistance provided by the fluid against movement of the paddles 222. Accordingly, the paddles 222, and therefore also the corresponding flappers 204, move relatively slowly during this time.

With respect to the manufacture of the damping mechanisms 206, it will be appreciated that in certain embodiments the damping mechanism 206 may be manufactured as an integral part of a split flapper valve 110, or any one of numerous other types of valves 110. In other embodiments, the damping mechanism 206 may be manufactured separately for implementation in any one or more of numerous different types of valves 110. Similarly, it will be appreciated that the damping mechanism 206 can be used in any one of numerous different types of systems 100.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A check valve comprising:
a valve body having an upstream side, a downstream side, and a valve flow channel that extends between the upstream and downstream sides;
a flapper rotationally mounted on the valve body and movable between a closed position, in which the flapper at least substantially seals the valve flow channel, and an open position, in which the flapper at least substantially unseals the valve flow channel; and
a damping mechanism mounted on the valve body, the damping mechanism comprising:
a main body having at least an inner wall defining a chamber, the chamber having fluid therein;
a paddle disposed within the chamber, the paddle coupled to the flapper and moved thereby between a first position and a second position when the flapper is in the closed position and the open position, respectively, the paddle configured to force fluid from at least a section of the chamber when approaching the first position or the second position; and
a fluid channel coupled to at least the section of the chamber, the fluid channel configured to allow egress of the fluid out of the section of the chamber at least at a first egress rate when the paddle moves from the first position to a predetermined intermediate position between the first and second positions, and to allow egress of the fluid out of the section of the chamber at least at a second egress rate when the paddle moves from the predetermined intermediate position to the second position, the second egress rate being less than the first egress rate,
whereby movement of the flapper from the closed position to the open position is at least at a first movement rate when the paddle moves from the first position to the intermediate position, and at least at a second movement rate when the paddle moves from the predetermined intermediate position to the second position, the second movement rate being less than the first movement rate.

2. The check valve of claim 1, further comprising:
a flapper stop coupled to the valve body and configured to limit the flapper movement in the open position.

3. The check valve of claim 2, wherein:
the flapper stop is coupled to the damping mechanism main body.

4. The check value of claim 1, further comprising:
a shaft coupled between the paddle and the flapper.

5. The check valve of claim 1, further comprising:
one or more seals disposed within the chamber to at least substantially prevent egress of fluid out of the chamber.

6. The check valve of claim 1 wherein:
the fluid channel comprises a groove disposed in the inner wall.

7. The check valve of claim 1, further comprising:
a second flow channel that extends between the upstream and downstream sides;
a second flapper rotationally mounted on the valve body and movable between a closed position, in which the second flapper at least substantially seals the second flow channel, and an open position, in which the second flapper unseals the flow channel; and
a second damping mechanism mounted on the valve body, the second damping mechanism comprising:
a main body having at least an inner wall defining a chamber, the chamber having fluid therein;
a paddle disposed within the chamber, the paddle coupled to the second flapper and moved thereby between a first position and a second position when the second flapper is in the closed position and the open position, respectively, the paddle configured to force fluid from at least a section of the chamber when approaching the first position or the second position; and
a fluid channel coupled to at least the section of the chamber, the fluid channel configured to allow egress of the fluid out of the section of the chamber at least at a first egress rate when the paddle moves from the first position to a predetermined intermediate position between the first and second positions, and to allow egress of the fluid out of the section of the chamber at least at a second egress rate when the paddle moves from the predetermined intermediate position to the second position, the second egress rate being less than the first egress rate,
whereby movement of the second flapper from the closed position to the open position is at least at a first movement rate when the paddle moves from the first position to the intermediate position, and at least at a second movement rate when the paddle moves from the predetermined intermediate position to the second position, the second movement rate being less than the first movement rate.

8. The check valve of claim 7, further comprising:
a second shaft coupled between the second damping mechanism paddle and the second flapper.

9. The check valve of claim 1, wherein the inner wall further defines an arc including at least a first region, a second region, and an intermediate region between the first and second regions, wherein:
the fluid in the chamber is allowed to flow around the paddle when the paddle is not at least partially adjacent to the first or second region; and
the fluid in the chamber is at least-substantially blocked from flowing around the paddle when the paddle is at least partially adjacent to the first or second region.

10. A check valve comprising:
a valve body having an upstream side, a downstream side, and a plurality of valve flow channels that extend between the upstream and downstream sides;
a plurality of flappers rotationally mounted on the valve body, each flapper movable between a closed position, in which such flapper at least substantially seals a valve flow channel, and an open position, in which such flapper at least substantially unseals a valve flow channel; and
a plurality of damping mechanisms mounted on the valve body, each damping mechanism comprising:
a main body having at least an inner wall defining a chamber, the chamber having fluid therein;
a paddle disposed within the chamber, the paddle coupled to a corresponding flapper and moved thereby between a first position and a second position when the corresponding flapper is in the closed position and the open position, respectively, the paddle configured to force fluid from at least a section of the chamber when approaching the first position or the second position; and
a fluid channel coupled to at least the section of the chamber, the fluid channel configured to allow egress of the fluid out of the section of the chamber at least at a first egress rate when the paddle moves from the first position to a predetermined intermediate position between the first and second positions, and to allow egress of the fluid out of the section of the chamber at least at a second egress rate when the paddle moves from the predetermined intermediate position to the second position, the second egress rate being less than the first egress rate,
whereby movement of the corresponding flapper from the closed position to the open position is at least at a first movement rate when the paddle moves from the first position to the intermediate position, and at least at a second movement rate when the paddle moves from the predetermined intermediate position to the second position, the second movement rate being less than the first movement rate.

11. The check valve of claim 10, wherein each damping mechanism further comprises:
a flapper stop coupled to the valve body and the main body of each of the damping mechanisms, the flapper stop configured to limit movement of the plurality of flappers in the open position.

12. The check value of claim 10, further comprising:
one or more shafts coupled between the paddle and the corresponding flapper of each of the damping mechanisms.

13. The check valve of claim 10, further comprising:
one or more seals disposed within the chamber of each of the damping mechanisms to at least substantially prevent egress of fluid out of the chamber.

14. The check valve of claim 10, wherein the inner wall of each damping mechanism further defines an arc including at least a first region, a second region, and an intermediate region between the first and second regions, wherein:
the fluid in the chamber is allowed to flow around the paddle when the paddle is not at least partially adjacent to the first or second region; and
the fluid in the chamber is at least substantially blocked from flowing around the paddle when the paddle is at least partially adjacent to the first or second region.

15. A damping system for a valve with a flapper movable between an open position and a closed position, the damping system comprising:
a main body having at least an inner wall defining a chamber, the chamber having fluid therein;
a paddle disposed within the chamber, the paddle coupled to the flapper and moved thereby between a first position and a second position when the flapper is in the closed position and the open position, respectively, the paddle configured to force fluid from at least a section of the chamber when approaching the first position or the second position; and
a fluid channel coupled to at least the section of the chamber, the fluid channel configured to allow egress of the fluid out of the section of the chamber at least at a first egress rate when the paddle moves from the first position to a predetermined intermediate position between the first and second positions, and to allow egress of the fluid out of the section of the chamber at least at a second egress rate when the paddle moves from the predetermined intermediate position to the second position, the second egress rate being less than the first egress rate,
whereby movement of the flapper from the closed position to the open position is at least at a first movement rate when the paddle moves from the first position to the intermediate position, and at least at a second movement rate when the paddle moves from the predetermined intermediate position to the second position, the second movement rate being less than the first movement rate.

16. The damping system of claim 15, wherein:
the paddle is configured to be coupled to the flapper via a shaft.

17. The damping system of claim 15, further comprising:
one or more seals disposed within the chamber to at least substantially prevent egress of fluid out of the chamber except through the fluid channel.

18. The damping system of claim 15, wherein:
the fluid channel comprises a groove disposed in the inner wall.

19. The damping system of claim 15, wherein the inner wall further defines an arc including at least a first region, a second region, and an intermediate region between the first and second regions, wherein:
the fluid in the chamber is allowed to flow around the paddle when the paddle is not at least partially adjacent to the first or second region; and
the fluid in the chamber is at least substantially blocked from flowing around the paddle when the paddle is at least partially adjacent to the first or second region.

20. The damping system of claim 15, wherein:
the damping system is configured to be mounted on a valve body of a valve.
